(19) United States
(12) Patent Application Publication
(10) Pub. No.: US 2003/0092422 A1
(43) Pub. Date: May 15, 2003

(54) Method and apparatus for providing a transfer protocol

(76) Inventor: Stephen A. Muoio, Cross River, NY (US)

Correspondence Address: DRINKER BIDDLE & REATH, ONE LOGAN SQUARE, 18TH AND CHERRY STREETS, PHILADELPHIA, PA, 19103-6996, US

(21) Appl. No.: 10/292,652

(22) Filed: Nov. 12, 2002

Related U.S. Application Data
(60) Provisional application No. 60/345,865, filed on Nov. 9, 2001.

(51) Int. Cl. H04M 11/00

(52) U.S. Cl. 455/405; 455/407

(57) ABSTRACT

A prepaid call is initiated by an end user using a prepaid account and the remaining value of the prepaid account is determined. The remaining value is compared to a threshold value. The prepaid call is then selectively transferred to an operator platform responsive to either the result of the comparison or responsive to a signal received from the end user.

### RELATED APPLICATION

The present invention is related to and claims priority from U.S. Provisional Application entitled TTI Transfer Protocol and Method, filed on Nov. 9, 2001, Serial No. 60/345,865, the disclosure of which is incorporated herein by reference in its entirety.

### FIELD OF THE INVENTION

The present invention is directed to prepaid telephone calls and, in particular, to a method and apparatus for implementing a transfer protocol for handling prepaid calls.

### BACKGROUND OF THE INVENTION

Prepaid calling cards are generally issued by a particular carrier (the “prepaid carrier”). A prepaid calling card corresponds to a prepaid account having a calling value measured by a quantity of time (e.g. minutes) or currency (e.g. dollars). An end user uses the prepaid account to place telephone calls via the prepaid carrier and the prepaid carrier deducts the value of a placed call from the prepaid account.

If the value of a prepaid calling card is entirely depleted while the end user is on a call, the prepaid carrier terminates the call. There is a need for a transfer protocol to transfer the prepaid call in response to a trigger, such as the a depleted value of the prepaid calling card.

### SUMMARY OF THE INVENTION

In one aspect, the invention comprises a method for handling a prepaid call initiated by an end user using a prepaid account. The method includes the step of determining a remaining value of the prepaid account. The remaining value is compared to a threshold value. The prepaid call is then selectively transferred to an operator platform responsive to either the result of the comparison or responsive to a signal received from the end user.

In another aspect of the invention, the method further includes the step of transmitting a message to the end user if the remaining value is less than the threshold value.

In yet another aspect of the invention, the threshold value is zero and the prepaid call is transferred to the operator platform when the value of the prepaid account is fully depleted.

In another aspect, the invention comprises a carrier platform that is coupled to receive a prepaid call from an end user using a prepaid account. The carrier platform determines value remaining in the prepaid account, compares the remaining value to a threshold value, and then selectively transfers the prepaid call to an operator platform responsive to the results of the comparison and a signal received from the end user.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is a flow chart illustrating an exemplary transfer protocol according to the present invention.

### DETAILED DESCRIPTION OF THE INVENTION

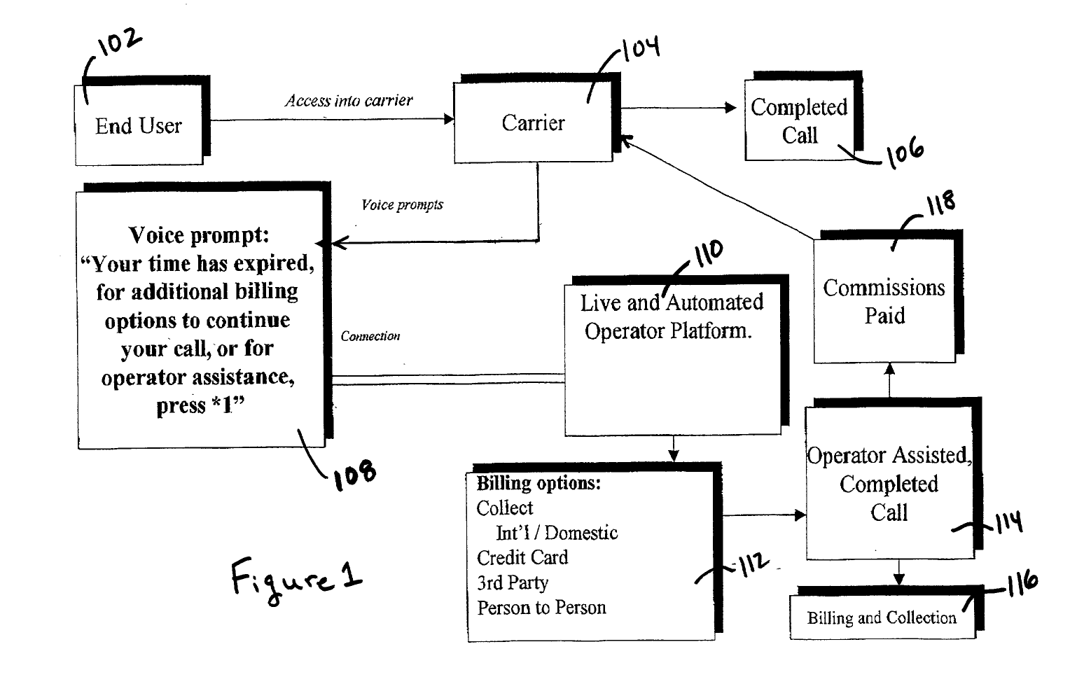

Referring to the drawings, in which like reference numerals indicate like elements, there is shown in FIG. 1 a flow chart illustrating an exemplary transfer protocol according to the present invention. In step 102, the end user having a prepaid calling card attempts to access the prepaid carrier switch. The prepaid carrier may be a CLEC or an IXC. The end user may attempt to gain access to the carrier's network via various methods including an 800 or toll free call, direct connect, a primary independent carrier (PIC) or via local dial tone, depending on the carrier type and the services offered by the carrier. The connection between the end user and the carrier is referred to as the first leg or the A-leg of the call.

In step 104, the prepaid carrier verifies the prepaid account of the end user. The prepaid carrier may verify the end user's account by checking a PIN code, for example, and by checking to ensure that the account includes a positive remaining account value (in time or dollars). If the account is verified, the prepaid carrier then couples the end user to a requested destination via a second leg (the B-leg) of the call, thereby completing the call in step 106.

The prepaid carrier provides a voice prompt to the end user in step 108. The voice prompt may be provided to the end user upon initiation of the call, upon full depletion of the prepaid account value, or during the call. The voice prompts can be played at anytime during the call and may be implemented using a dual-tone multi-frequency (DTMF) interruptible feature. The voice prompts 108 may be customized and recorded in multiple languages to accommodate various callers.

A voice prompt provided upon initiation of the call may announce the availability of operator options so the end user (or caller) is aware that the services are available. The end user will then know how to access an operator at any time during the call by may then entering a code such as “*1,” for example.

A voice prompt may also be provided to an end user when the value of the end user's prepaid account is less than a threshold value. During a prepaid call, the prepaid carrier determines the remaining value of the prepaid account. The prepaid carrier may compare the remaining value to a threshold value. When the remaining value is less than the threshold, the voice prompt is provided. For example, if the threshold is thirty seconds, when the value of the prepaid account value drops below the thirty second threshold, a voice prompt may be provided to the end user to advise the caller that thirty seconds remain and to advise the end user of how (e.g. by dialing an access code such as “0” or “*1”) to access an operator platform. A voice prompt may state, for example: “you have 30 seconds remaining, for operator assistance press 0 now.” The voice prompt may also advise the end user that the call may automatically be transferred to the operator platform when the prepaid account is fully depleted.

A voice prompt may also be provided when the prepaid account is fully depleted. The voice prompt may state, for example: “Your time has expired. For additional billing options to continue your call, or for operator assistance, press *1” or “Your time has expired. You are automatically being transferred to an operator.”

If the end user selects to be routed to an operator or upon automatic routing to an operator upon account depletion, the end user is connected to an operator services platform in step 110 for providing live and/or automated operator services. The end user is connected to the operator services platform via the prepaid carrier which may be connected to the operator platform via a dedicated connection such as a T-1, DS1 or DS3 line, depending on call volume. Toll free or 800 access, or local dial up access may also be implemented for connecting the prepaid carrier to the operator platform if supported by the operator platform, if the prepaid switch can provide the necessary signaling required to deliver the call digits to properly rate and bill the operator call, and depending on the location and functionality of the prepaid carrier and operator platform switches.

Once the call is handed off to the operator platform by the prepaid carrier, the B-leg is terminated while the initial A-leg connection between the prepaid carrier platform and the operator platform remains in place until the operator call is disconnected. This allows the prepaid carrier to monitor call duration and to audit call records. The operator services portion of this call is supported and maintained by the operator service provider (OSP). In an exemplary embodiment, the operator platform and/or the prepaid carrier implement ANI (automatic number identification) translation. The ANI translation is used to determine the originating number so that the operator platform may generate a CDR (call detail record) for accurate billing of the operator assisted calls despite their being transferred to the OSP via the prepaid carrier.

The operator service provider provides the end user with one or more billing options in step 112, such as placing a collect (international or domestic), third party, person to person, station to station, calling card and commercial credit card call. The operator service call, or operator assisted call is billed by the OSP. The charges associated with this call will be billed to the party that was called if the caller opted to call collect. Rates are determined by the OSP but can be created or modified to satisfy any individual carrier requirement.

The operator platform may provide the end user with access to multiple operator service providers or to a carrier of the end user's choice. For example, upon the termination of the prepaid call, the end user may be given the option to choose to complete the operator assisted call using AT&T, MCI, or US Sprint and a discount operator service.

Once the billing and carrier for the operator assisted call is secured, the operator platform completes the operator assisted call (another B-leg) in step 114. When the operator assisted call is terminated, the OSP bills the appropriate party depending on the chosen billing option in step 116. The OSP may be arranged to pay the prepaid carrier a commission in step 118 for the call referral and for the continued use of the A-leg during the operator assisted call.

The present invention benefits end users or subscribers by providing them with an alternative to their calls being completed terminated when their prepaid calling cards are fully depleted. In addition, the transfer to an operator platform to generate an operator assisted call provides an additional revenue stream to the prepaid carrier.

The foregoing describes the invention in terms of embodiments foreseen by the inventors for which an enabling description was available, although insubstantial modifications of the invention, not presently foreseen may nonetheless represent equivalents thereto.

What is claimed is:

1. A method for handling a prepaid call initiated by an end user using a prepaid account, the method comprising the steps of:
a. determining a remaining value of the prepaid account;
b. comparing the remaining value to a threshold value; and
c. selectively transferring the prepaid call to an operator platform responsive to one of results of the comparison and a signal received from the end user.

2. The method according to claim 1 further comprising the step of transmitting a message to the end user if the remaining value is less than the threshold value.

3. The method according to claim 1 wherein the threshold value is zero and the prepaid call is transferred to the operator platform when the value of the prepaid account is fully depleted.

4. The method according to 1 further comprising the steps of:
a. providing the end user with at least one payment option;
b. receiving a signal corresponding to a selected payment option; and
c. selectively completing a second leg of the transferred call responsive to the user selection.

5. A carrier platform coupled to receive a prepaid call from an end user using a prepaid account, the carrier platform arranged to determine a remaining value of the prepaid account, compare the remaining value to a threshold value, and selectively transfer the prepaid call to an operator platform responsive to one of results of the comparison and a signal received from the end user.
